(19) United States
(12) Patent Application Publication
(10) Pub. No.: US 2025/0175926 A1
(43) Pub. Date: May 29, 2025

(54) UNSUPERVISED ACCESS POINT FLOOR CLASSIFICATION

(71) Applicant: Cisco Technology, Inc., San Jose, CA (US)

(72) Inventors: Audrey YAZDANPARAST, Akron, OH (US); Peiman AMINI, Fremont, CA (US); Brian D. HART, Sunnyvale, CA (US); Bahador AMIRI, Saratoga, CA (US)

(21) Appl. No.: 18/520,078

(22) Filed: Nov. 27, 2023

(51) Int. Cl. H04W 64/00; G01C 5/06

(52) U.S. Cl. CPC H04W 64/00; G01C 5/06

(57) ABSTRACT

Systems and techniques for performing automated access point (AP) localization are described. An example technique includes receiving air pressure sensor data from a set of APs deployed in an environment. The air pressure sensor data is evaluated using an unsupervised clustering model. At least one of (i) a number of floors in the environment or (ii) for each AP, which floor in the environment the AP is located is determined. An indication of at least one of (i) the number of floors or (ii) each AP's floor location is transmitted.

### TECHNICAL FIELD

Embodiments presented in this disclosure generally relate to systems and techniques for determining the locations of access points in a geographic area, such as a building(s) or other structure(s).

### BACKGROUND

Network systems may include a number of access points in a geographic area, such as a building or other structure. Access points are hardware devices that facilitate connection of wireless devices to a hard-wired network in the geographic area. For example, a building may include one or more networks for communication of data between different devices associated with the one or more networks. Some buildings may include a relatively large number of access points installed throughout the building, often in locations that are not readily apparent. In some instances, the locations of the access points may be recorded at the time of installation of the access points. However, some locations may be inaccurately recorded at the time of installation. In addition, over time some access points may be moved, resulting in the location of the access points changing, and further, access points may be added to a network, for example, as the size of an organization grows. As a result, it may be difficult and time consuming to find the access points, rendering performance of service or maintenance associated with access points difficult.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system, according to one embodiment.

FIG. 2 further illustrates certain components of the system illustrated in FIG. 1, according to one embodiment.

FIG. 3 is a flowchart of an example method for performing automated AP localization, according to one embodiment.

FIG. 4 is a graph of air pressure sensor data received from a set of APs over time, according to one embodiment.

FIG. 5 is a flowchart of an example method for performing automated AP localization, according to one embodiment.

FIG. 6 illustrates an example computing device, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment described herein is a computer-implemented method. The computer-implemented method includes receiving air pressure sensor data from a set of access points (APs) deployed in an environment. The computer-implemented method also includes evaluating the air pressure sensor data using an unsupervised clustering model. The computer-implemented method further includes determining at least one of (i) a number of floors in the environment or (ii) for each AP, which floor in the environment the AP is located. The computer-implemented method further includes transmitting an indication of at least one of (i) the number of floors or (ii) each AP's floor location.

Another embodiment described herein is a computing system. The computing system includes one or more memories collectively storing computer-executable instructions, and one or more processors communicatively coupled to the one or more memories. The one or more processors are collectively configured to execute the computer-executable instructions to cause the computing system to perform an operation. The operation includes receiving air pressure sensor data from a set of access points (APs) deployed in an environment. The operation also includes evaluating the air pressure sensor data using an unsupervised clustering model. The operation also includes determining at least one of (i) a number of floors in the environment or (ii) for each AP, which floor in the environment the AP is located. The operation further includes transmitting an indication of at least one of (i) the number of floors or (ii) each AP's floor location.

Another embodiment described herein includes one or more non-transitory computer-readable storage medium. The one or more non-transitory computer-readable storage medium includes, in any combination, computer-executable code, which, when collectively executed by one or more processors perform an operation. The operation includes receiving air pressure sensor data from a set of access points (APs) deployed in an environment. The operation also includes evaluating the air pressure sensor data using an unsupervised clustering model. The operation also includes determining at least one of (i) a number of floors in the environment or (ii) for each AP, which floor in the environment the AP is located. The operation further includes transmitting an indication of at least one of (i) the number of floors or (ii) each AP's floor location.

### EXAMPLE EMBODIMENTS

Environments (e.g., school campus, business complex, and other multi-building environments) may deploy large numbers of access points (APs) (e.g., dozens of APs, hundreds of APs, or thousands of APs) across one or more buildings in the environment. The APs in such environments may be centrally managed via an on-site platform (also referred to as a management platform), such as a controller (e.g., wireless local area network (LAN) controller (WLC)) or cloud platform, as illustrative, non-limiting examples. When the APs are initially installed, the APs may be manually positioned on maps stored within (or accessible to) the on-site platform for the purposes of asset management, radio frequency (RF) prediction, and other management tasks. One reference example of a cloud platform is Cisco Spaces®.

However, manually positioning APs in this manner is often a time-consuming and error prone task. Additionally, in cases where manual repositioning of an AP is needed (e.g., due to the AP being subsequently moved to a different location), the manual repositioning may not be triggered or performed due to complexities associated with manual positioning.

Accordingly, embodiments herein describe systems and techniques for performing automated localization of APs in an environment based in part on air pressure sensor data obtained from the APs. The automated (or semi-automated) system described herein may accurately localize APs in a geospatial coordinate system, based on air pressure sensor data. For example, the automated (or semi-automated) system may use the air pressure sensor data to automatically and accurately identify the number of floors in a building and determine a location (e.g., geospatial coordinate) of each AP within the respective floor of the building. By performing localization in this manner, embodiments can create a scalable localization system that can minimize the opportunity for user error and dynamically update the AP locations if and when the APs move.

For example, given an environment having multiple APs spread across multiple buildings, the automated (or semi-automated) system can use the techniques described herein to (i) determine which APs belong to particular buildings in the environment, (ii) for each building, determine which respective set of APs belong to respective floors of the building, (iii) for each floor, determine which respective set of APs belong to respective areas within the floor, or (iv) determine a combination thereof. The system may then perform X-Y localization or X-Y-Z localization for each AP using a variety of localization techniques/algorithms. Having global geospatial coordinates for the APs may be technically advantageous for a wireless network since the APs may use the global geospatial coordinates to aid clients in performing localization (e.g., client localization), which can improve roaming performance, as an illustrative example.

As used herein, a hyphenated form of a reference numeral refers to a specific instance of an element and the un-hyphenated form of the reference numeral refers to the collective element. Thus, for example, device “12-1” refers to an instance of a device class, which may be referred to collectively as devices “12” and any one of which may be referred to generically as a device “12.”

Note, the techniques described herein for performing automated AP localization based on air pressure sensor data may be incorporated into (such as implemented within or performed by) a variety of wired or wireless apparatuses (such as nodes). In some implementations, a node includes a wireless node. Such wireless nodes may provide, for example, connectivity to or for a network (such as a wide area network (WAN) such as the Internet or a cellular network) via a wired or wireless communication link. In some implementations, a wireless node may include an AP or a controller.

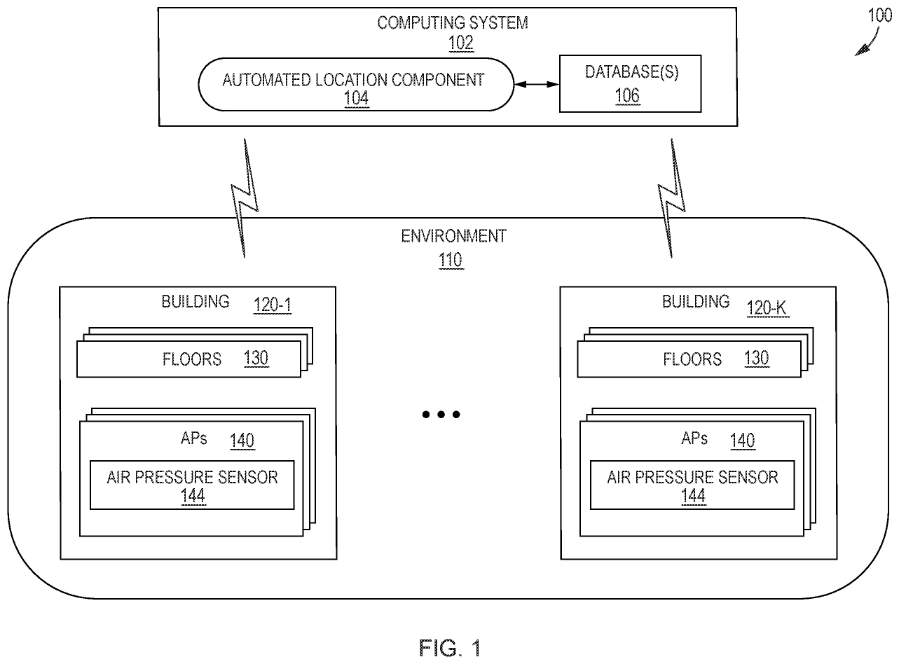

FIG. 1 illustrates an example system 100 in which one or more techniques described herein can be implemented, according to one embodiment. As shown, the system 100 includes a computing system 102 and multiple APs 140 deployed within an environment 110. The environment 110 is generally representative of any geographic area in which one or more networks are deployed. For example, the environment 110 can include a geographic area (e.g., campus, business complex, city plaza, etc.) with multiple buildings (or other structures), a single building (or other structure), or a combination thereof, as illustrative reference examples. Here, for example, the environment 110 includes multiple (multi-level or multi-floor) buildings 120-1 to 120-K, where each building 120 includes a respective certain number of floors 130. Note that while FIG. 1 depicts a certain number of buildings 120 within the environment 110, in certain embodiments, the environment 110 may include any number of buildings or other structures.

The APs 140 may include any hardware devices that create a wireless local area network (WLAN), for example, that facilitates connection of wireless devices to a hard-wired network in the environment 110. Other types of access point devices are contemplated. In certain embodiments, an AP is a fixed station that communicates with client stations (STAs) (not shown in FIG. 1) and may be referred to as a base station, wireless device, or some other terminology. The APs 140 may communicate with one or more client STAs on the downlink and uplink. The downlink (e.g., forward link) is the communication link from the AP 140 to the client STA(s), and the uplink (e.g., reverse link) is the communication link from the client STA(s) to the AP 140. Additionally, each AP 140 may include one or more radios that the AP 140 can use to form links with one or more client STA(s). In general, the APs 140 may form any suitable number of links for communication using any suitable frequencies or bands.

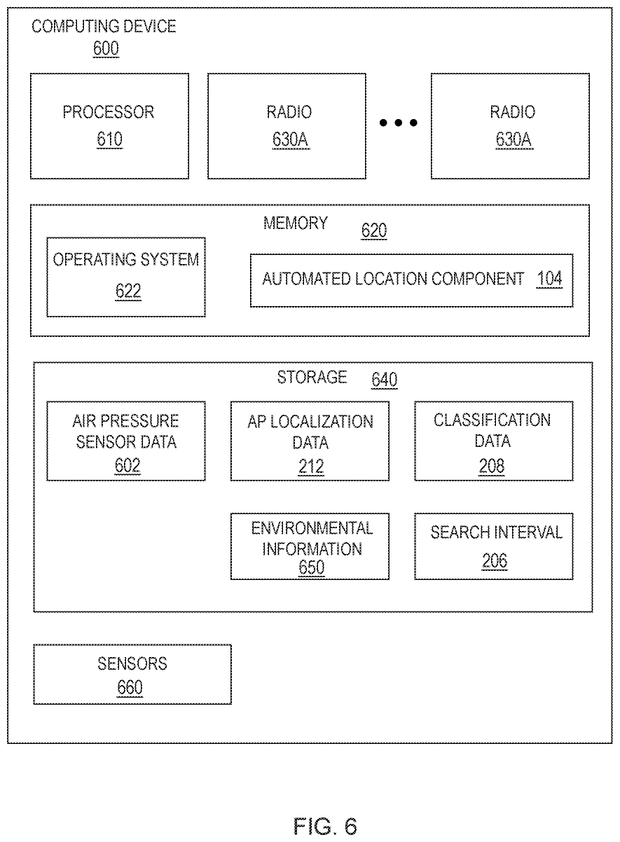

In certain embodiments, each AP 140 deployed within the environment 110 includes an air pressure sensor 144 (also referred to as a barometric measuring device). The air pressure sensor 144 may be configured to generate sensor data that indicates an elevation of the respective AP 140. In certain embodiments described in greater detail below, the sensor data generated by the air pressure sensors 144 may be used to perform AP localization, which may include, for example, determining which floor 130 of which building 120 in the environment 110 each AP is located. Although not shown, in certain embodiments, the AP 140 may include additional sensors, such as global positioning system (GPS) sensors, accelerometers, gyroscopes, and inertial measurement units (IMUs), as illustrative, non-limiting examples. Example hardware that may be included in an AP 140 is discussed in greater detail with regard to FIG. 6.

The computing system 102 is generally representative of a controller that couples to and provides coordination and control for the APs 140. For example, the computing system 102 may handle adjustments to transmission power, channels, authentication, and security for the APs 140. The computing system 102 may also assign and coordinate the links formed between client STA(s) and the APs 140 as well as handle traffic management for the APs 140.

In the depicted embodiment, the computing system 102 includes an automated location component 104 and one or more databases 106. The automated location component 104 is configured to perform one or more techniques described herein for localizing APs in the environment 110, based on air pressure sensor data. The database(s) 106 are representative of storage systems that may include information associated with the APs 140 in the system 100. For example, the database(s) 106 may include air pressure senor data (obtained from the APs 140), AP coordinate data, communication link metrics (e.g., received signal strength indication (RSSI), modulation and coding scheme (MCS), or a combination thereof, as illustrative examples. The database(s) 106 may also include logic (e.g., artificial intelligence (AI)/machine learning (ML) models, localization algorithms, and/or clustering algorithms) for performing localization.

In certain embodiments, the computing system 102 is included within or integrated with an AP 140. In certain embodiments, the computing system 102 is separate from the APs 140 and provides control for those APs. In FIG. 1, for example, the computing system 102 may communicate with the APs 140 via a (wired or wireless) backhaul. The APs 140 may also communicate with one another, e.g., directly or indirectly via a wireless or wireline backhaul. Example hardware that may be included in a computing system 102 is discussed in greater detail with regard to FIG. 6.

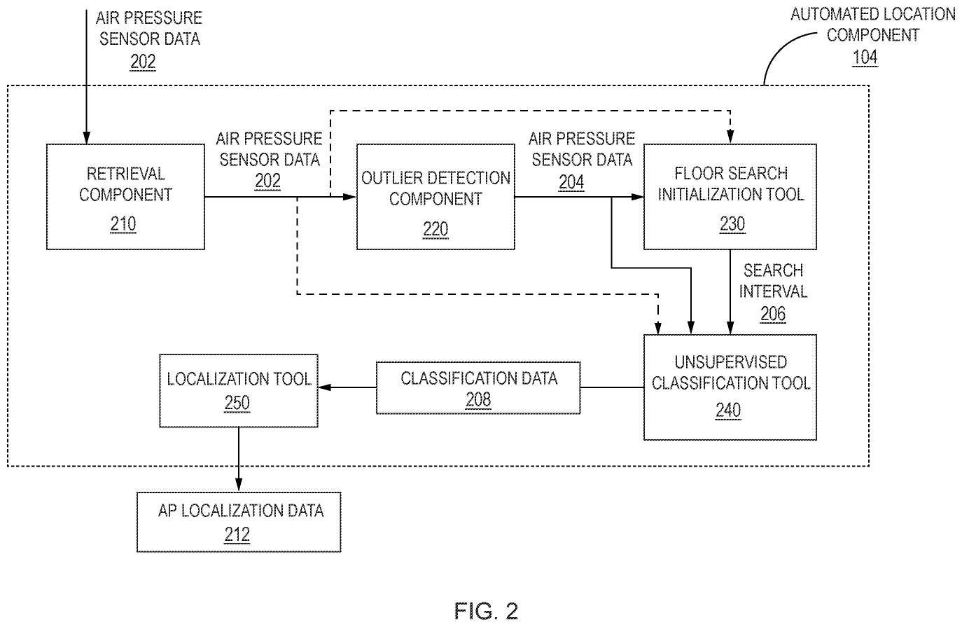

FIG. 2 further illustrates the automated location component 104 of the system 100 illustrated in FIG. 1, according to one embodiment. As shown, the automated location component 104 includes, without limitation, a retrieval component 210, an outlier detection component 220, a floor search initialization tool 230, an unsupervised classification tool 240, and a localization tool 250, each of which may include software, hardware, or combinations thereof.

The retrieval component 210 is generally configured to obtain air pressure sensor data 202 from APs 140 deployed in an environment 110. The retrieval component 210 may obtain air pressure sensor data 202 periodically (e.g., based on a predetermined time interval), based on occurrence of an event (e.g., installation time, AP reboot, AP update, new or updated AP location, etc.), based on a command from a network administrator, or a combination thereof. The retrieval component 210 may obtain the air pressure sensor data 202 using a variety of communication protocols. In one example, the retrieval component 210 may use a request-response mechanism, in which the retrieval component 210 requests the air pressure sensor data from the AP(s) 140 and the AP(s) 140 send a response with the air pressure sensor data. In another example, the retrieval component 210 may obtain the air pressure sensor data 202 via a push mechanism, in which the AP(s) 140 pushes the sensor data to the retrieval component 210 when certain conditions, such as predetermined time, event, and command are satisfied. Note, however, that other communication protocols are contemplated.

The outlier detection component 220 is generally configured to detect and remove from the air pressure sensor data 202 values that satisfy certain conditions. For example, the outlier detection component 220 may remove outlier values (e.g., values that are outside of a predefined threshold range) from the air pressure sensor data 202 to generate modified air pressure sensor data 204. In certain embodiments, the outlier detection component 220 performs unsupervised outlier detection using a local outlier factor (LOF) algorithm.

A LOF algorithm is an unsupervised anomaly detection method that computes the local density deviation of a given data point with respect to its neighbors. The LOF considers as outliers the samples that have a substantially lower density than their neighbors. In embodiments where the outlier detection component 220 uses a LOF algorithm, the LOF algorithm measures the local deviation of the density of a given sample (e.g., air pressure sensor value) with respect to its neighbor's data. The anomaly score that is computed may depend on how sparse the sample is with respect to the surrounding neighborhood AP air pressure.

The floor search initialization tool 230 is generally configured to determine an initial floor search interval 206 for the unsupervised AP localization, based on the air pressure sensor data 202, the air pressure sensor data 204, or a combination thereof. For example, the floor search interval 206 may be used as the search interval of the number of clusters for the unsupervised classification tool 240, described in greater detail below. In certain embodiments, the floor search interval 206 is defined as [nFloorMin, nFloorMax] and is calculated based on (i) the absolute air pressure difference between the highest and lowest reported air pressure values in the air pressure sensor data 202 or air pressure sensor data 204, (ii) the range of anticipated floor spacings between different floor levels, and (iii) the range of rates of air pressure change with height, where:

$$nFloorMin = floor ( max {P}^{*} ( maxAirPressure - minAirPressure ) / minFloorSpacing ) \qquad ( 1 )$$

$$nFloorMax = ceil ( min {P}^{*} ( maxAirPressure - minAirPressure ) / maxFloorSpacing ) \qquad ( 2 )$$

where the floor ( ) operator rounds down to the nearest integer, the ceil ( ) operator rounds up to the nearest integer, maxP is the maximum height change for a given pressure change, minP is the minimum height change for a given pressure change, maxAirPressure is the maximum air pressure recorded by APs, minAirPressure is the minimum air pressure recorded by APs, maxFloorSpacing is the maximum floor spacing anticipated for a building (e.g., 6 meters), and minFloorSpacing is the minimum floor spacing anticipated for a building (e.g., 2.75 meters). Note, maxP and minP may be based on the weather conditions and altitudes of interest (e.g., from at or below sea level to up to 2000 meters in altitude).

In certain embodiments, the floor search interval 206 is defined as [nFloorMin*, nFloorMax*], where nFloorMin* is set to a predefined value (e.g., “1”) and nFloorMax* is set to another predefined value (e.g., the largest number of floors that can be found anywhere within a given environment). Here, the predefined values for nFloorMin* and nFloorMax* be obtained from a database (or storage system) that includes information associated with the environment (e.g., number of buildings in the environment, tallest building in the environment, shortest building in the environment, and other information). For example, assuming the environment is a college campus, the floor search initialization tool 230 can obtain information from a database indicating the tallest building within the campus, and set nFloorMax* to the number of floors of the tallest building within the campus.

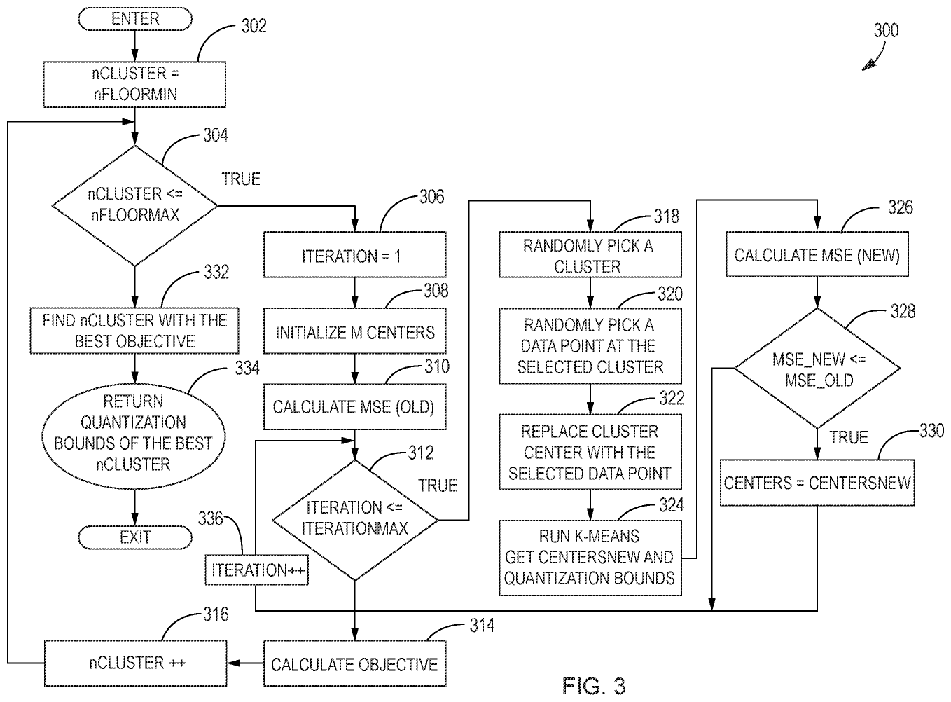

The unsupervised classification tool 240 is generally configured to implement an unsupervised ML algorithm to determine a number of floors within each building and to determine each AP's corresponding floor location within a respective building, based on the air pressure sensor data 202 or the air pressure sensor data 204. As used herein, an “unsupervised” ML algorithm generally refers to an ML algorithm that can implement floor identification for a set of APs without a set of inputs (e.g., number of floors, floor search interval, etc.) provided by a user (e.g., network administrator). In certain embodiments, the unsupervised ML algorithm is an unsupervised K-means clustering algorithm. For example, the unsupervised K-means clustering algorithm described herein may use the air pressure sensor data 202 or 204 as well as the search interval 206 to generate classification data 208, which includes an estimate of the number of floors 130 in each building 120 in the environment 110 and each AP's corresponding floor location. Note, the unsupervised classification tool 240 is described in greater detail below with respect to FIG. 3.

The localization tool 250 is generally configured to perform AP localization based on the classification data 208. For example, the localization tool 250 can perform X-Y localization to determine X-Y coordinates of each AP within a building, X-Y-Z localization to determine X-Y-Z coordinates of each AP within a building, or a combination thereof. The localization tool 250 can generate AP localization data 212, which includes the geographical coordinates of the APs 140, AP floor classification information, building floor information (e.g., number of floors in each building), or a combination thereof. Note, the localization tool 250 can use a variety of localization algorithms to determine the geographical coordinates of the APs 140. Such localization algorithms may include, but are not limited to, received signal strength indicator (RSSI)-based localization algorithms, time difference of arrival (TDoA) and/or angle of arrival (AoA) based localization algorithms, centroid algorithm, weighted centroid algorithm, particle swarm optimization, etc.

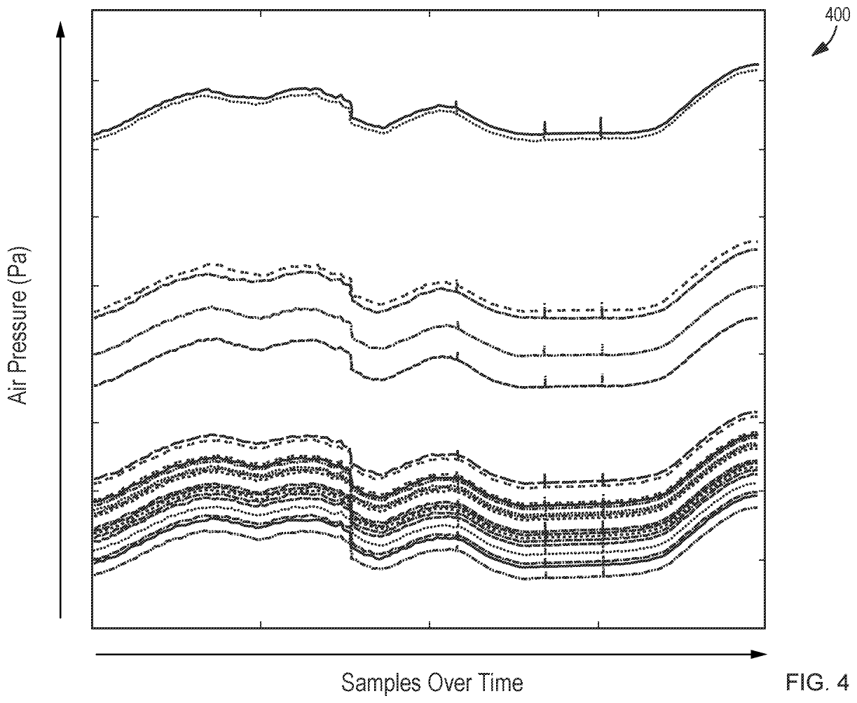

FIG. 3 is a flowchart of an example method 300 for performing automated AP localization using an unsupervised clustering algorithm, according to one embodiment. The method 300 may be implemented by one or more components of the automated location component 104. In a particular embodiment, the method 300 is implemented by the unsupervised classification tool 240. Note, the method 300 may be performed for each instance of air pressure sensor data (e.g., air pressure sensor data 202 or air pressure sensor data 204) obtained from a set of APs or may be performed for a processed (or modified) version of the air pressure sensor data over a time interval (e.g., calculated mean, calculated median, filtered, smoothed, etc.). A reference example of live air pressure sensor data from 24 APs deployed within 3 floors is depicted in graph 400 of FIG. 4. Note the method 300 may be performed upon receiving an indication of one or more APs being deployed in the environment, receiving an indication of one or more deployed APs changing locations in the environment, occurrence of a predetermined time interval, a command, or a combination thereof.

As described below, method 300 may use two loops (e.g., an outer loop and an inner loop) to perform automated AP localization. The method 300 may use the outer loop to perform an initialization of the inner loop and run an evaluation of each result from a run of the inner loop. The method 300 may use the inner loop to update the cluster centers. For example, as described below, the inner loop may update the cluster centers by calculating the mean of all the data points assigned to a given cluster and then update that cluster's center to the calculated mean. If the updated cluster centers (resulting from the k-means process) lead to a lower MSE than the previous MSE (associated with the old cluster centers), then the old cluster centers are replaced with the updated ones. This process may be repeated until the cluster centers no longer change or a maximum number of iterations is reached.

In method 300, the initialization of the inner loop may include blocks 302, 304, 306, 308, and 310. For example, the method 300 may enter by initializing the number of clusters (nCluster) based on the search interval 206 (e.g., [nFloorMin, nFloorMax]). For instance, at block 302, the method 300 sets an initial value of the number of clusters (nCluster) to nFloorMin. At block 304, the method 300 determines whether nCluster is less than or equal to nFloorMax. If nCluster is greater than nFloorMax, then the method 300 proceeds to block 332. If nCluster is less than or equal to nFloorMax, then the method 300 proceeds to block 306.

At block 306, the method 300 initializes a starting value of the parameter “Iteration” for the inner loop (e.g., blocks 312, 318, 320, 322, 324, 326, 328, 330, and 336) to “1.” At block 308, the method 300 initializes a predefined number (e.g., M) of cluster centers (e.g., c1, c2, c3, . . . , cM). The initial values for the M cluster centers c1, c2, . . . , cM may be selected by linearly spacing the interval between the maximum and minimum reported air pressure sensor values. The data values of the air pressure sensor data are then clustered to the nearest cluster. At block 310, an initial mean squared error (MSE) is calculated for the initial M cluster centers, e.g., using the following Equation (3):

$$MSE = {\sum }_{i = 1}^{M} {\sum }_{x ∈ {s}_{k}} {‖ {x}_{{s}_{k}} - {c}_{k} ‖}^{2} \qquad ( 3 )$$

where xₛ_{ₖ} is data within the k-th cluster with center cₖ and M is the total number of clusters.

Once the inner loop is initialized, the method 300 within the inner loop may iteratively use the k-means clustering algorithm to find the optimum cluster centers (e.g., of air pressure sensor values) that minimize the sum of distances between all data values and their associated clusters, e.g., according to the objective function in Equation (4):

$${arg min}_{[ {c}_{1} , ... , {c}_{K} ]} {\sum }_{i = 1}^{M} {\sum }_{x ∈ {s}_{k}} {‖ {x}_{{s}_{k}} - {c}_{k} ‖}^{2} \qquad ( 4 )$$

where xₛ_{ₖ} is data within the k-th cluster with center cₖ and M is the total number of clusters. For example, in each iteration of the inner loop, the method 300 may replace one (current) cluster center (cₖ) with a data point xₛ_{ₖ} (within that cluster). The method 300 may then use the replaced cluster center to modify the initial values of the k-means clustering algorithm. If the output from the k-means clustering algorithm (e.g., cluster centers and data values within the clusters) leads to a lower MSE than the latest MSE associated with the current cluster, then the current cluster centers are replaced by the cluster centers output from the k-means clustering algorithm.

More specifically, at block 312, the method 300 determines whether the current Iteration is less than or equal to a predefined maximum number of Iterations (IterationMax). If so, then the method 300 proceeds to block 318. If not, then the method proceeds to block 314. At block 318, the method 300 randomly selects one of the M clusters. At block 320, the method 300 randomly selects a data point xₛ_{ₖ} within the selected cluster. At block 322, the method 300 replaces the selected cluster center with the selected data point. At block 324, the method 300 performs k-means clustering to generate a new set of cluster centers (CentersNew) and quantization bounds. At block 326, the method 300 calculates a new MSE, e.g., using Equation (3). At block 328, the method 300 compares the new MSE with the initial MSE (determined at block 310). If the new MSE is less than or equal to the initial MSE, then the method 300 proceeds to block 330, where the (current) cluster centers are set equal to the new set of cluster centers (CentersNew). The method 300 then proceeds to block 336, where the number of iterations (Iteration) is incremented by one. If, at block 328, the new MSE is greater than the initial MSE, then the method 300 proceeds to block 336.

After the last iteration of the inner loop (e.g., when Iteration is greater than IterationMax), the cluster centers and the associated data values within the clusters) are passed to the outer loop for evaluation. In certain embodiments, the outer loop performs the evaluation based on an objective function, such as Davies-Bouldin Index (DBI). For example, at block 314, the method 300 computes the DBI for the respective cluster according to Equation (5):

$$DBI = \frac{1}{M} {\sum }_{k , j = 1 : M} {max}_{k \neq j} {R}_{k , j} \qquad ( 5 )$$

where

$${R}_{k , j} = \frac{{MSE}_{k} + {MSE}_{j}}{{‖ {c}_{j} - {c}_{k} ‖}^{2}} , for {MSE}_{k} = \frac{1}{‖ {s}_{k} ‖} {\sum }_{x ∈ {s}_{k}} {‖ x - {c}_{k} ‖}^{2} .$$

In general, the DBI measures the ratio of the intra-cluster distortion to the inter-cluster distance of the nearest cluster. After calculating the DBI for the respective cluster, the method 300 increments the current cluster number by “1” at block 316. In this manner, the outer loop iterates over each presumed number of clusters (e.g., number of floors) with an inner loop that involves a predetermined number of iterations. Once nCluster is greater than nFloorMax, the method 300 finds the nCluster with the best objective (block 332) (e.g., smallest DBI). At block 334, the method 300 returns the quantization bounds of the best nCluster. In this manner, the method 300 may determine the number of floors in the building based on the following:

$$arg min \{ DBI\_n \} \qquad ( 6 )$$

where nFloorMin≤n≤nFloorMax.

As a reference example, consider the following scenario in which a set of 2D data points {A(2,3), B(3,3), C(8,8), D(9,9) is grouped into 2 clusters (k=2). In this scenario, the k-means clustering algorithm may choose k initial “centroids” randomly from the data points. For example, A(2,3) and C(8,8) may be chosen as the initial centroids from the above set of 2D data points. The k-means clustering algorithm may then assign each data point to the closest centroid, where the distance is measured using Euclidean distance. For example, for point A, it may be assigned to the first cluster, since the distance to centroid A is 0 and the distance to centroid C is approximately 8.49. For point B, it may be assigned to the first cluster, since point B is closer to centroid A than centroid C. For point C, it may be assigned to the second cluster, since point C is closer to centroid C than centroid A. For point D, it may be assigned to the second cluster, since point D is closer to centroid C than centroid A. Accordingly, in this scenario, the first cluster (Cluster 1) may include point A and point B, and the second cluster (Cluster 2) may include point C and point D.

After assigning each data point to the closest centroid, the algorithm may calculate new or updated centroids. For example, the algorithm may calculate the mean of all the data points in each cluster and move the centroid to that mean. In this scenario, the new centroid for Cluster 1 may be the mean of points A and B (e.g., 2.5, 3), and the new centroid for Cluster 2 may be the mean of points C and D (e.g., 8.5, 8.5). The algorithm may then repeat the assignment and update steps using the updated centroids (2.5, 3) and (8.5, 8.5) until the algorithm converges with two clusters: (i) Cluster 1 with point A and point B; and (ii) Cluster 2 with point C and point D. In certain embodiments, because the choice of initial centroids can impact the final clusters, the k-means algorithm may be run multiple times with different initializations. Certain embodiments may then calculate the DBI for Clusters 1 and 2 to determine the clustering quality. Here, the DBI for Clusters 1 and 2 is equal to 0.39. In this scenario, calculating DBI may involve the following steps (1)-(5):
1. For each cluster, compute the average distance between each point in the cluster and the centroid of that cluster. This is (Sᵢ), the scatter (or dispersion) of cluster (i).
2. For each pair of clusters (i) and (j), compute the distance between the two cluster centroids (D(i, j)).
3. For each pair of clusters (i) and (j), compute (R (i, j)={Sᵢ+Sⱼ}/{D(i, j)}). This measures the ratio of the sum of the scatter of two clusters to the distance between the centroids.
4. For each cluster (i), find the maximum (R (i, j)) across all (j≠i). Let's call this (Rᵢ).
5. The DBI is the average of all (Rᵢ).

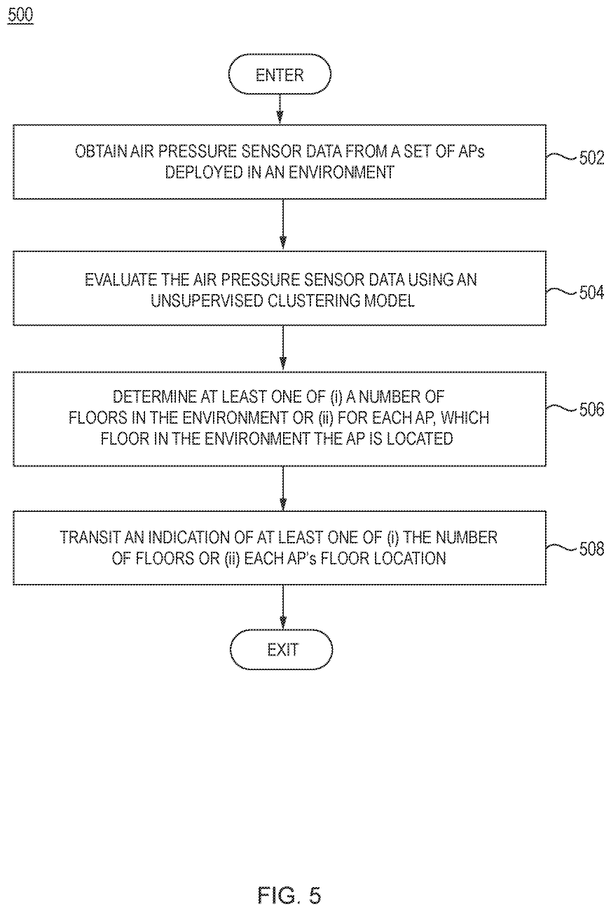

FIG. 5 is a flowchart of a method 500 for performing automated AP localization, according to one embodiment. Method 500 may be performed by an automated location component (e.g., automated location component 104).

Method 500 may enter at block 502, where the automated location component receives air pressure sensor data from a set of APs deployed in an environment (e.g., environment 110). The environment may include one or more multi-floor (or multi-level) structures (e.g., buildings 120).

At block 504, the automated location component evaluates the air pressure sensor data using an unsupervised clustering model (e.g., k-means clustering algorithm). In certain embodiments, the evaluation in block 504 may be based on at least one set of cluster centers and assignment of data values to the at least one set of cluster centers.

For example, the automated location component may generate a floor search interval (e.g., [nFloorMin, nFloorMax]) based at least in part on the air pressure sensor data and information associated with the environment (e.g., range of rates of air pressure change with height, anticipated floor spacings in the environment, weather conditions, altitude, etc.). The automated location component may also determine multiple estimates of a number of clusters (e.g., nCluster), based on the floor search interval. For each estimated number of clusters, the automated location component may (i) determine a first set of cluster centers (e.g., M cluster centers) based on the air pressure sensor data and (ii) assign each data value of the air pressure sensor data to one of the first set of cluster centers, based on a distance (e.g., Euclidean) of the data value to the respective cluster center.

In such embodiments, the evaluation in block 504 may include, for each estimated number of clusters, iteratively running the unsupervised clustering model to minimize the respective distances between the first set of cluster centers and the data values. The output of the unsupervised clustering model may include a second set of cluster centers and respective assignments of each data value of the air pressure sensor data to one of the second set of cluster centers. The evaluation in block 504 may also include, for each estimated number of clusters, determining a respective value of an objective function (e.g., DBI) based on the second set of cluster centers and the respective assignments of data values to the second set of cluster centers associated with the estimated number of clusters.

At block 506, the automated location component determines at least one of (i) a number of floors in the environment or (ii) for each AP, which floor in the environment the AP is located, based on the evaluation. In certain embodiments, the determination of the number of floors in the environment includes (i) determining which of the plurality of estimates of the number of clusters has a lowest DBI value and (ii) determining the number of floors in the environment to be equal to the estimated number of clusters with the lowest DBI value. In certain embodiments, the determination of the floor in the environment the AP is located includes (i) determining which data values of the air pressure sensor data belong to the AP and (ii) determining the AP is located on the floor corresponding to the respective one of the second set of clusters that includes the data values belonging to the AP.

At block 508, the automated location component transmits an indication of at least one of (i) the number of floors or (ii) each AP's floor location to a computing system (e.g., computing system 102).

In certain embodiments, the automated location component may also (as part of method 500) use a localization algorithm to determine a geographical coordinate of one or more of the set of APs for each respective floor in the environment. The geographical coordinate may be in a two-dimensional coordinate system or a three-dimensional coordinate system.

FIG. 6 illustrates an example computing device 600, according to one embodiment. The computing device 600 can be configured to perform one or more techniques described herein for performing automated AP localization. For example, the computing device 600 can perform method 300, method 500, and any other techniques (or combination of techniques) described herein. In certain embodiments, the computing device 600 is a network controller. The computing device 600 includes, without limitation, a processor 610, a memory 620, one or more radios 630a-n (generally, radio 630), storage 640, and one or more sensors 660.

The processor 610 may be any processing element capable of performing the functions described herein. The processor 610 represents a single processor, multiple processors, a processor with multiple cores, and combinations thereof. The communication interfaces 630 facilitate communications between the computing device 600 and other devices. The communications interfaces 630 are representative of wireless communications antennas and various wired communication ports.

The memory 620 may be either volatile or non-volatile memory and may include RAM, flash, cache, disk drives, and other computer readable memory storage devices. Although shown as a single entity, the memory 620 may be divided into different memory storage elements such as RAM and one or more hard disk drives. As shown, the memory 620 includes various instructions that are executable by the processor 610 to provide an operating system 622 to manage various functions of the computing device 600. The memory 620 also includes an automated location component 104 configured to perform one or more techniques described herein.

The storage 640 may be a disk drive storage device. Although shown as a single unit, the storage 640 may be a combination of fixed and/or removable storage devices, such as fixed disc drives, removable memory cards, or optical storage, network attached storage (NAS), or a storage area-network (SAN). In certain embodiments, the storage 640 may include air pressure sensor data 602, AP localization data 212, classification data 208, environmental information 650 (e.g., range of rates of air pressure change with height in the environment, anticipated floor spacings in the environment, weather conditions, altitude, etc.), and search interval(s) 206. The air pressure sensor data 602 may include air pressure sensor data 202, air pressure sensor data 204, or a combination thereof.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As used herein, “a processor,” “at least one processor,” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refers to a single memory configured to store data and/or instructions or multiple memories configured to collectively store data and/or instructions.

As will be appreciated by one skilled in the art, the embodiments disclosed herein may be embodied as a system, method or computer program product.

Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A computer-implemented method comprising:
receiving air pressure sensor data from a set of access points (APs) deployed in an environment;
evaluating the air pressure sensor data using an unsupervised clustering model;
determining at least one of (i) a number of floors in the environment or (ii) for each AP, which floor in the environment the AP is located; and
transmitting an indication of at least one of (i) the number of floors or (ii) each AP's floor location.

2. The computer-implemented method of claim 1, further comprising generating a floor search interval based at least in part on the air pressure sensor data and information associated with the environment.

3. The computer-implemented method of claim 2, further comprising:
determining a plurality of estimates of a number of clusters, based on the floor search interval; and
for each estimated number of clusters:
determining a first set of cluster centers based on the air pressure sensor data; and
assigning each data value of the air pressure sensor data to one of the first set of cluster centers, based on a distance of the data value to the respective cluster center.

4. The computer-implemented method of claim 3, wherein evaluating the air pressure sensor data comprises, for each estimated number of clusters, iteratively running the unsupervised clustering model to minimize the respective distances between the first set of cluster centers and the data values, wherein an output of the unsupervised clustering model comprises a second set of cluster centers and respective assignments of each data value of the air pressure sensor data to one of the second set of cluster centers.

5. The computer-implemented method of claim 4, wherein evaluating the air pressure sensor data comprises, for each estimated number of clusters, determining a respective value of an objective function based on the second set of cluster centers and the respective assignments of data values to the second set of cluster centers associated with the estimated number of clusters.

6. The computer-implemented method of claim 5, wherein the objective function is a Davies-Bouldin Index (DBI).

7. The computer-implemented method of claim 5, wherein determining the number of floors in the environment comprises:
determining which of the plurality of estimates of the number of clusters has a lowest value of the objective function; and
determining the number of floors in the environment to be equal to the estimated number of clusters with the lowest value of the objective function.

8. The computer-implemented method of claim 7, wherein determining the floor in the environment the AP is located comprises:
determining which data values of the air pressure sensor data belong to the AP; and
determining the AP is located on the floor corresponding to the respective one of the second set of clusters comprising the data values belonging to the AP.

9. The computer-implemented method of claim 1, further comprising, for each floor in the environment, using a localization algorithm to determine a geographical coordinate of one or more of the set of APs located on the floor.

10. The computer-implemented method of claim 9, wherein the geographical coordinate is in a two-dimensional coordinate system or a three-dimensional coordinate system.

11. A computing system comprising:
one or more memories collectively storing computer-executable instructions; and
one or more processors communicatively coupled to the one or more memories, the one or more processors being collectively configured to execute the computer-executable instructions to cause the computing system to perform an operation comprising:
receiving air pressure sensor data from a set of access points (APs) deployed in an environment;
evaluating the air pressure sensor data using an unsupervised clustering model;
determining at least one of (i) a number of floors in the environment or (ii) for each AP, which floor in the environment the AP is located; and
transmitting an indication of at least one of (i) the number of floors or (ii) each AP's floor location.

12. The computing system of claim 11, the operation further comprising generating a floor search interval based at least in part on the air pressure sensor data and information associated with the environment.

13. The computing system of claim 12, the operation further comprising:
determining a plurality of estimates of a number of clusters, based on the floor search interval; and
for each estimated number of clusters:
determining a first set of cluster centers based on the air pressure sensor data; and
assigning each data value of the air pressure sensor data to one of the first set of cluster centers, based on a distance of the data value to the respective cluster center.

14. The computing system of claim 13, wherein evaluating the air pressure sensor data comprises, for each estimated number of clusters, iteratively running the unsupervised clustering model to minimize the respective distances between the first set of cluster centers and the data values, wherein an output of the unsupervised clustering model comprises a second set of cluster centers and respective assignments of each data value of the air pressure sensor data to one of the second set of cluster centers.

15. The computing system of claim 14, wherein evaluating the air pressure sensor data comprises, for each estimated number of clusters, determining a respective value of an objective function based on the second set of cluster centers and the respective assignments of data values to the second set of cluster centers associated with the estimated number of clusters.

16. The computing system of claim 15, wherein the objective function is a Davies-Bouldin Index (DBI).

17. The computing system of claim 15, wherein determining the number of floors in the environment comprises:
determining which of the plurality of estimates of the number of clusters has a lowest value of the objective function; and
determining the number of floors in the environment to be equal to the estimated number of clusters with the lowest value of the objective function.

18. The computing system of claim 17, wherein determining the floor in the environment the AP is located comprises:
determining which data values of the air pressure sensor data belong to the AP; and
determining the AP is located on the floor corresponding to the respective one of the second set of clusters comprising the data values belonging to the AP.

19. The computing system of claim 11, the operation further comprising, for each floor in the environment, using a localization algorithm to determine a geographical coordinate of one or more of the set of APs located on the floor.

20. One or more non-transitory computer-readable storage medium comprising, in any combination, computer-executable code, which, when collectively executed by one or more processors perform an operation comprising:
receiving air pressure sensor data from a set of access points (APs) deployed in an environment;
evaluating the air pressure sensor data using an unsupervised clustering model;
determining at least one of (i) a number of floors in the environment or (ii) for each AP, which floor in the environment the AP is located; and
transmitting an indication of at least one of (i) the number of floors or (ii) each AP's floor location.
